(19) United States
(12) Patent Application Publication
(10) Pub. No.: US 2003/0132842 A1
(43) Pub. Date: Jul. 17, 2003

(54) Baggage identifying/locating system

(76) Inventor: Lin Chia-Yen, Taipei (TW)

Correspondence Address: Donald C. Casey, Suite 100, 311 North Washington Street, Alexandria, VA, 22314, US

(21) Appl. No.: 10/045,056

(22) Filed: Jan. 15, 2002

(51) Int. Cl. G08B 13/14

(52) U.S. Cl. 340/568.1; 340/571; 340/539.13; 340/572.1

(57) ABSTRACT

A baggage identifying/locating system includes a responsive unit installed in the baggage and adapted to receive a predetermined radio signal and to output a visual/audio signal marking the location of the baggage, and a radio transmitter unit operated by a user to output the radio signal to activate the responsive unit, causing the responsive unit to output the visual/audio signal.

### BACKGROUND OF THE INVENTION

The present invention relates to baggage, specifically to a system, which identifies baggage and marks its location

Most of the time, luggage counters are crowded, because passengers wait close to a luggage conveyor in order to find and get their luggage. However, it is tiring that one has to pay lots of attention on moving luggage in order to find their own. And it is troublesome if one sees similar luggage, so he/she has to check nametags, either on the moving conveyor or after getting it down on the ground. Thus a device which helps to identify, to locate, and to trace luggage is helpful to solve this hassle.

### SUMMARY OF THE INVENTION

The present invention has been accomplished under the circumstances in view. It is one object of the present invention to provide a baggage identifying/locating system, which helps users search personal baggage quickly. According to the present invention, the baggage identifying/locating system comprises a power source, a responsive unit installed in the baggage, and a radio transmitter unit for operation by users to output a radio signal to activate/deactivate the responsive unit, causing the responsive unit to output a signal marking the location of the baggage. The output signal of the responsive unit can be a visual signal, an audio signal, or visual and audio combined signals.

### BRIEF DESCRIPTION OF THE DRAWINGS

FIG. 1 is a perspective view of the present invention.

FIG. 2 is a system block diagram of the present invention.

### DETAILED DESCRIPTION OF THE PREFERRED EMBODIMENT

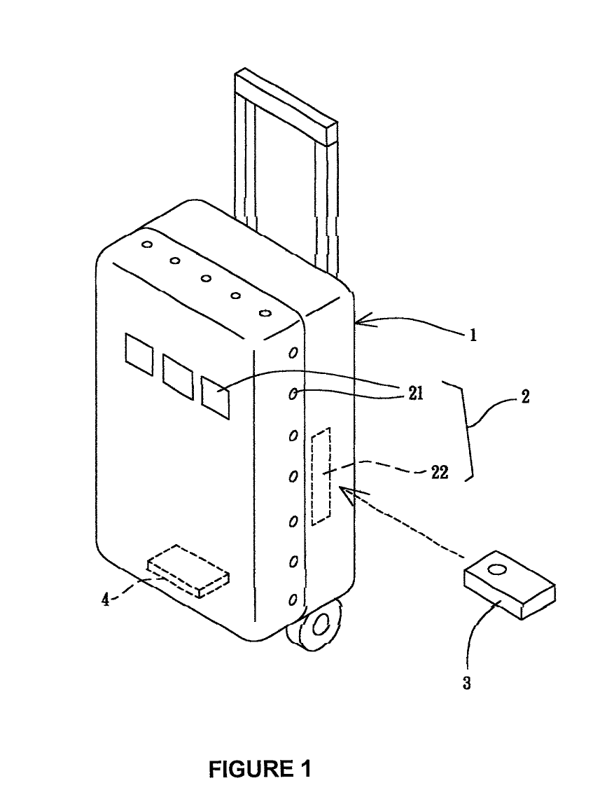

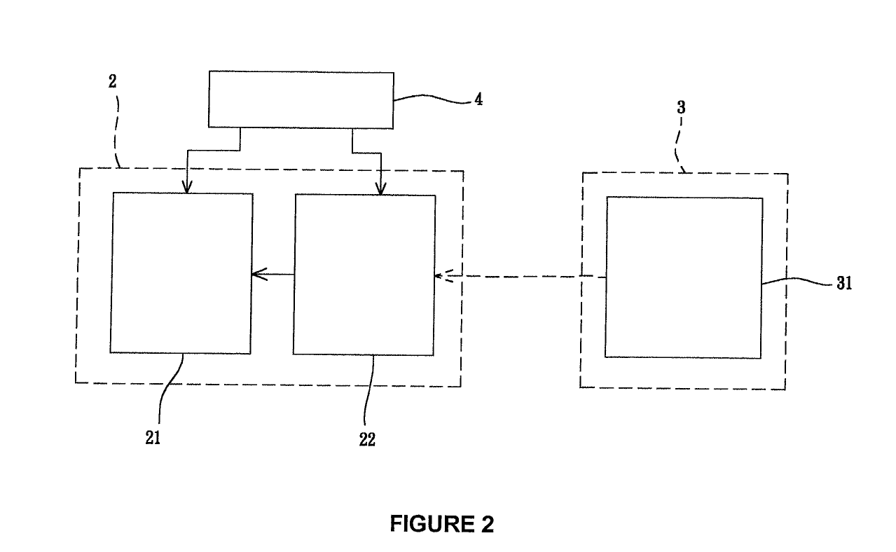

Referring to FIGS. 1 and 2, a baggage identifying/locating system in accordance with the present invention comprises a baggage 1, a responsive unit 2 installed in the baggage 1, a radio transmitter unit 3, and a power supply unit 4 installed in the baggage 1 and electrically connected to the responsive unit 2.

The baggage 1 is a mobile container adapted to hold personal items.

The responsive unit 2 comprises a signal-generating device 21, and a radio signal receiving circuit 22 electrically connected to the signal-generating device 21. The signal-generating device 21 may be variously embodied. For example, the signal generating device 21 can be visual signal generating means comprised of a set of LEDs (light emitting diodes) and a control circuit, audio signal generating means comprised of a speaker and a control circuit, or the combination of the visual signal generating means and the audio signal generating means. According to the present preferred embodiment, the signal-generating device 21 is a combination of visual signal generating means and audio signal generating means. The radio signal receiving circuit 22 is adapted to receive a particular radio PIN (personal identification number) signal, and to activate/deactivate the signal-generating device 21 upon receipt of the particular radio PIN signal.

The power supply unit 4 is electrically connected to the responsive unit 2 to provide the signal generating device 21 and the radio signal receiving circuit 22 with necessary electrical power.

The radio transmitter unit 3 comprises a radio signal transmitting circuit 31 adapted to generate a radio PIN (personal identification number) signal. The construction and appearance of the radio transmitter unit 3 may be similar to a regular remote controller. By means of pressing the emit button of the radio transmitter unit 3, the radio transmitter unit 3 is driven to emit a radio PIN signal, which can activate/deactivate the signal generating device 22 through receiving circuit 22.

When in use, the radio transmitter unit 3 is carried by a user. When searching the baggage 1, the user operates the radio transmitter unit 3 to emit the preset radio PIN signal. If the baggage 1 is out of the effective range of the radio PIN signal, the baggage 1 gives no response. If the baggage 1 is within the effective range of the radio PIN signal, the radio signal receiving circuit 22 immediately receives the radio PIN signal and then activates the signal-generating device 21, causing the signal-generating device 21 to output audio and visual signals. Thus, the user quickly finds out the location of the baggage 1. Then the user can operates the radio transmitter unit 3 again to emit the preset radio PIN signal, or the other preset radio PIN signal to deactivate the signal-generating device 21.

As indicated above, the present invention provides a baggage identifying/locating system, which causes the baggage to output audio and visual signals, marking its location when a user send the preset radio PIN signal and is received by the responsive unit of the baggage.

A prototype of baggage identifying/locating system has been constructed with the features of FIGS. 1 and 2. The baggage identifying/locating system functions smoothly to provide all of the features discussed earlier.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. A baggage identifying/locating system comprising:
a baggage;
a responsive unit installed in said baggage, said the responsive unit comprising a signal generating device adapted to output a signal marking the location of said baggage, and a radio signal receiving circuit adapted to activate/deactivate said signal generating device upon receipt of a predetermined radio PIN (personal identification number) signal or signals;
a radio transmitter unit for operation by the user to output a predetermined radio PIN signal or signals to activate/deactivate said signal generating device; and
a power supply unit installed in said baggage and electrically connected to said responsive unit to provide said responsive unit with necessary electrical power.

2. The baggage identifying/locating system as claimed in claim 1 wherein said signal-generating device is a visual signal-generating device.

3. The baggage identifying/locating system as claimed in claim 1 wherein said signal-generating device is an audio signal-generating device.
